(19) United States
(12) Patent Application Publication
(10) Pub. No.: US 2002/0148315 A1
(43) Pub. Date: Oct. 17, 2002

(54) Adjustable speed reducer assembly

(76) Inventors: Robert J. Mittendorf, Traverse City, MI (US); Brian C. Tuck, Traverse City, MI (US)

Correspondence Address: TREXLER, BUSHNELL, GIANGIORGI,, BLACKSTONE & MARR, LTD., 36th Floor, 105 West Adams Street, Chicago, IL, 60603, US

(21) Appl. No.: 10/144,534

(22) Filed: May 13, 2002

Related U.S. Application Data
(63) Continuation-in-part of application No. 09/616,418, filed on Jul. 14, 2000, now Pat. No. 6,386,059.

(51) Int. Cl. F16H 1/16; F16H 55/18

(52) U.S. Cl. 74/425; 74/409

(57) ABSTRACT

An speed reducer assembly is provided along with a method and apparatus for adjusting the speed reducer assembly to achieve zero backlash. The speed reducer assembly includes a split worm with a fixed worm segment and a floating worm segment which mesh with the teeth of the gear. The position of the worm relative to the gear can be precisely and accurately adjusted without disassembly of the speed reducer or removal of the speed reducer assembly from the housing. Elimination of a constant spring force on the floating worm segment of the split worm also provides for the elimination of drag which results in a speed reducer assembly with increased efficiency. The elimination of drag also reduces the wear on the elements of the speed reducer assembly.

### RELATED APPLICATION

This application is a continuation-in-part application of U.S. patent application Ser. No. 09/616,418, filed on Jul. 14, 2000 and entitled “Improved Adjustable Speed Reducer Assembly” which is incorporated in its entirety herein by reference.

### BACKGROUND OF THE INVENTION

This invention is generally directed to an improved adjustable speed reducer assembly. More particularly, the invention contemplates a speed reducer assembly which implements a split worm which can be adjusted to eliminate backlash within the speed reducer assembly.

Speed reducers have been used to transmit motion and power between non-intersecting shafts generally at right angles to one another. A typical speed reducer consists of an input shaft with threads and a toothed wheel or circular gear. The threaded input shaft, which is referred to as the worm is aligned to mesh with the teeth on the circular gear. A transfer of power occurs as the threads on the worm slide into contact with the teeth of the circular gear causing the circular gear to turn.

A common form of speed reducer uses a cylindrically shaped worm. The thread of the cylindrically shaped worm is of uniform diameter and generally contacts only a few wheel teeth. The number of teeth which the worm contacts can be significantly increased if the shape of the worm is modified from a cylindrical to conical. The conical worm is narrower at its center where it meets the top of the circular gear and wider at its ends conforming to the arc of the circular gear. The conical worm is sometimes referred to as a “double-enveloping” worm. Because the “double-enveloping” worm conforms to the arc of the circular gear, the worm thread contacts many more teeth on the circular gear. This additional contact between the worm thread and the circular gear's teeth increases the torque throughput allowing for higher load capacities, improved accuracy and reduced stress levels in the contact area thus extending the operating life of the speed reducer assembly.

A common problem encountered with the use of speed reducers is backlash. Backlash is generally defined as the play between the worm thread and the mating teeth. Backlash results in imprecise angular positioning of the speed reducer output shaft.

The reduction of backlash in the speed reducer allows for the speed reducer to be used in industries which require precise positioning and increased throughput. For example, metal cutting and forming machinery requires accuracy in the position of a work piece even if the work piece is heavy and repeated starting and stopping is necessary. In machinery used in printing and packaging applications, double enveloping worm gearing helps printing press rolls maintain precise print registration at very high speeds.

The backlash can be further reduced by using a split worm. A split worm is a worm which is formed with two worm segments placed together at the axial center of the worm thread. One segment of the worm is fixed in its bearing set, while the other segment is positioned laterally and is capable of reciprocal movement along the worm's axis and thus is referred to as the floating worm segment. Springs are implemented to manipulate the position of the floating worm segment so that a consistent clamping force is maintained on both sides of the gear. Half of the worm contacts the drive side of the gear while the other half of the worm makes continuous contact with the opposing side of the gear. The result of this split worm gear design is the elimination of backlash, making it ideal for applications which require extremely accurate positioning.

With this split worm arrangement, the spring force requirement on the floating worm segment is unique for each application. If the spring force is too light to resist the torque on the loaded gear, the worm will move out of position, misalign the gear mesh and destroy the gearset. If the spring force is too great, the system will require excessive force to turn, and will rapidly wear the gear.

The process of determining the proper spring force begins by determining output torque requirement. Using the output torque requirement, the spring force required to resist that output torque is then calculated. Springs are then selected and spacers are either added or removed to achieve the desired spring force. Removing additional spacers increases the spring force by incrementally compressing the spring within a fixed space. The spacers are provided in a variety of widths so as to allow for controlled incremental compression of the spring.

Setting the spring force on the split worm gear in this manner results in a number of difficulties. One such difficulty is that the measurement given for the desired output torque is often inaccurate. The inaccurate torque measurement often is not discovered until the spring force has been set, the housing has been reassembled and the speed reducer has been implemented. To adjust the spring force at this point requires first that the housing be opened and then requires that springs and/or spacers are added or removed to achieve the proper spring force. Often the spring force is set by the manufacturer and the speed reducer assembly is then shipped to a customer. The manufacturer sets the spring force based upon the customer provided measurement and calculation of the required spring force. Depending upon the accuracy of the measurements and calculations and how the speed reducer has been implemented, it may be necessary for a technician to travel to the site where the speed reducer assembly has been implemented to make the spring force adjustments. This, of course, adds to the cost of the speed reducer.

Another problem with the current method of setting the spring force is that springs are selected and implemented based upon their theoretical spring force ratings. However, there are high tolerances within these spring force ratings and inaccurate spring force settings result.

Another problem which is encountered in speed reducer assemblies is that the springs which are used to manipulate the position of the floating worm segment cause a constant residual drag which reduces the efficiency of the performance of the speed reducer assembly and the gear life.

The present invention provides an adjustable speed reducer assembly which overcomes the problems presented in the prior art and which provides additional advantages over the prior art, such advantages will become clear upon a reading of the attached specification in combination with a study of the drawings.

### OBJECTS AND SUMMARY

A general object of the present invention is to provide a speed reducer assembly with a minimal amount of backlash.

An object of an embodiment of the present invention is to provide a speed reducer whose backlash can be accurately sensed and easily adjusted.

Yet another object of an embodiment of the present invention is to provide a speed reducer assembly which reduces the drag between the worm and the gear.

Yet another object of an embodiment of the present invention is to provide a speed reducer assembly which reduces drag between the worm and the gear and which reduces torque fluctuations and transmission errors caused by different tooth thicknesses.

Briefly, and in accordance with at least one of the foregoing an embodiment of the present invention provides a speed reducer assembly and a method and apparatus for accurately positioning the worm relative to the gear of the speed reducer assembly to achieve zero backlash. The worm of the speed reducer assembly is a split worm and includes a fixed worm segment and a floating worm segment. Adjustment of the speed reducer assembly is accomplished by rotating an adjuster which positions the floating worm segment of the worm. The adjuster extends beyond the speed reducer housing, allowing adjustments to be made without disassembling the speed reducer. A method is provided for making periodic adjustments to the speed reducer assembly to maintain zero backlash.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a partial fragmentary, cross-section, side elevational view of the improved speed reducer assembly;

FIG. 2 is a partial fragmentary cross-section, side elevational view of a low drag speed reducer assembly;

FIG. 3 is a block diagram of the logic performed by a motor control used in connection with the speed reducer assembly shown in FIG. 2; and

FIG. 4 is a partial fragmentary cross-section, side elevational view of another speed reducer assembly.

### DESCRIPTION

While the invention may be susceptible to embodiment in different forms, there are shown in the drawings, and herein will be described in detail, specific embodiments with the understanding that the present disclosure is to be considered an exemplification of the principles of the invention, and is not intended to limit the invention to that as illustrated and described herein.

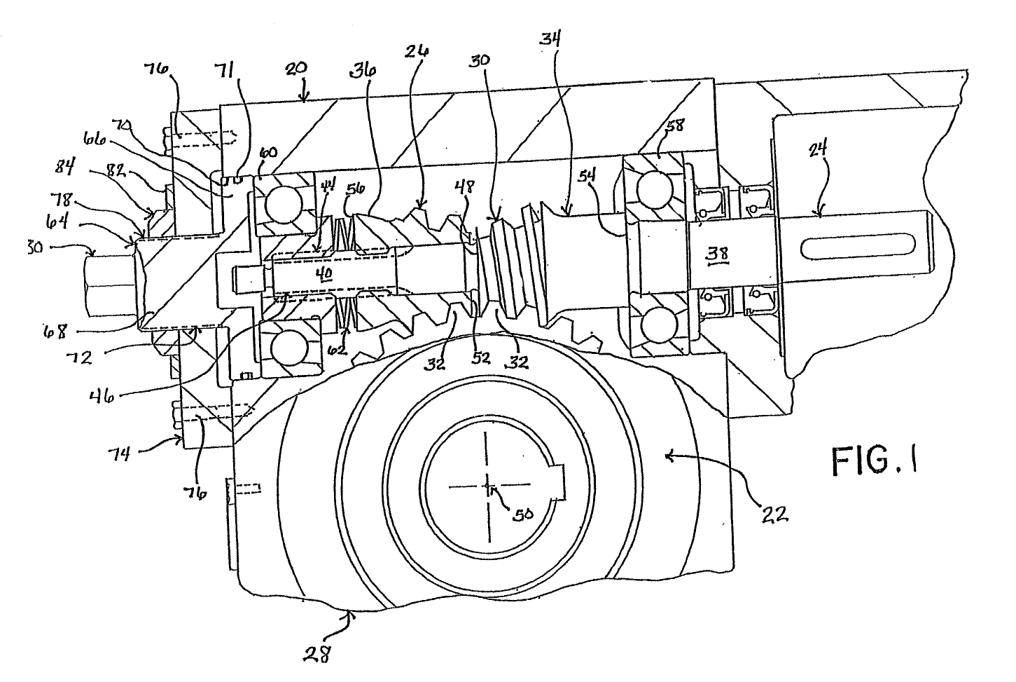

Attention is first drawn to FIG. 1. A housing 20 contains a speed reducer assembly 22. The speed reducer assembly 22 generally includes an input shaft 24, a worm 26 and a circular gear or wheel 28. As the input shaft 24 is rotated, power is transferred to the wheel 28 by way of the thread 30 which meshes with teeth 32 of the wheel 28.

The worm 26 is comprised of a fixed worm segment 34 and a floating worm segment 36. The input shaft 24 includes a splined portion 40 extending axially from the inner end 48 of the fixed worm segment 34 and a smooth portion 38 extending from the outer end 54 of the fixed worm segment 34. The input shaft 24 and the fixed worm segment 34 are positioned such that the inner end 48 of the fixed worm segment 34 is aligned with the center 50 of the wheel 28.

The floating worm segment 36 is slidably mounted to the splined portion 40 of the input shaft 24 and is positioned so that the inner end 52 of the floating worm segment 36 is aligned with the center 50 of the wheel 28 and proximate to the inner end 48 of the fixed worm segment 34. The thread 30 is formed such that when the inner end 52 of the floating worm segment 36 is proximate to the inner end 48 of the fixed worm segment 34 a nearly continuous thread is formed from the fixed worm segment 34 to the floating worm segment 36. The input shaft 24 is mounted within the housing 20 such that the thread 30 meshes with the teeth 32 of the wheel.

In the embodiment described and shown in the drawings, the diameter of the fixed worm segment 34 is narrower at its inner end 48 than at its outer end 54. The diameter of the floating worm segment 36 is also narrower at its inner end 52 than at its out end 56. Thus the fixed worm segment 34 and the floating worm segment 36 together form a double-enveloping worm. Although the embodiment shown implements a double-enveloping worm, a cylindrically shaped worm could also be implemented.

The smooth portion 38 of the input shaft 24 extends through and is supported by a first bearing assembly 58 which is mounted in the housing 20. The splined portion 40 of the input shaft 24 extends through and is supported by a second bearing assembly 60 which is mounted on the housing 20.

The inner diameter of the floating worm segment 36 contains a spline which mates with a reciprocating spline 46 on the splined portion 40 of the input shaft 24. The spline allows for the transfer of torque from the input shaft 24 to the floating worm segment 36. The inner diameter of the second bearing assembly 60 also contains a spline which mates with a reciprocating spline 46 on the splined portion 40 of the input shaft 24.

A spring assembly 62 is located at the outer end 56 of the floating worm segment 36 between the floating worm segment 36 and the second bearing assembly 60. The springs shown are disc springs, however, it is expected that one skilled in the art could substitute another form of spring to achieve a similar or identical function. Because the floating worm segment 36 is capable of axial movement, the spring assembly 62 acts to force the floating worm segment 36 toward the fixed worm segment 34. The result is a constant, firm, yet moveable clamping force applied to both sides of the wheel teeth 32.

An adjuster 64 is mounted proximate to the second bearing assembly 60. The adjuster 64 has an inner portion 66 and an outer portion 68. The inner portion 66 of the adjuster 64 is generally cylindrically shaped and its diameter is the generally the same as the diameter of the second bearing assembly 60. The inner portion 66 of the adjuster 64 is mounted within an aperture 70 in the housing 20. An O-ring 71 encircles the inner portion 66 of the adjuster 64. The outer portion 68 of the adjuster 64 is also generally cylindrically shaped and has a smaller diameter than the inner portion 66 and extends through an aperture 72 located at the center of an adjuster cap 74.

The adjuster cap 74 is mounted to the housing 20 through the use of screws 76. Threads 78 are located on the surface of the outer portion of the adjuster which mate with reciprocal threads in the hole of the adjuster cap 74. The mating threads allow the adjuster 64 to be rotated and secured into a desired position. The inner portion 66 of the adjuster 64 contacts the second bearing assembly 60.

As the adjuster 64 is rotated in one threaded direction, the inner portion 66 of the adjuster 64 pushes the second bearing assembly 60 inward which results in compression of the spring assembly 62. Rotation of the adjuster 64 in the opposite direction results in relaxation of the force on the spring assembly 62 which forces the second bearing assembly 60 outward. As noted above, compression or relaxation of the spring assembly 62 will depend on the direction the adjuster 64 is rotated. The adjuster 64 functions to controllably, precisely set the desired spring force.

A drive structure, such as wrench flats 80, is located at the outer end of the adjuster 64 so that the adjuster can be easily rotated. The adjuster provides a means for adjusting the spring force without requiring the disassembly of the speed reducer or opening of the speed reducer housing.

An indicator ring plaque 82 is mounted on the adjuster cap 74 and includes indicia to mark the degree to which the adjuster 64 has been rotated. The additional compression or relaxation of the spring assembly can be determined by observing the degree to which the adjuster has been rotated as indicated relative to the indicia on the ring. Using measured angles of rotation and the pitch of the adjuster screw the change in compression or relaxation can be calculated and the change in the spring force can be tabulated. Tables indicating the degree to which the adjuster should be rotated in order to achieve a desired spring force can then be provided to make accurate field adjustments. Such field adjustments might be accomplished by the end user thereby, possibly, eliminating the need for a skilled technician to attend to such adjustments in the field.

A jamming lock nut 84 is placed over the indicator plaque 82 and around the adjuster 64, proximate to the adjuster cap 74 to prevent inadvertent rotation of the adjuster 64. Once the adjuster is set to a pre-determined setting while being assembled, the lock nut 84 is tightened to maintain the “factory” setting. If adjustments are required in the field, the nut 84 is loosened and the adjustment is made to the assembly according to the tabular information and the indicia on the indicator 82. Once the desired setting is achieved, the nut 84 is tightened to prevent inadvertent rotation.

To assemble this adjustable speed reducer the desired output torque is first determined. From this value the necessary spring force is calculated. The desired spring force determines which springs will be used. For example, the theoretical spring force value of disc springs can be used to create a spring assembly of the desired spring force. The free height of this spring assembly is then calculated. Spacers are placed between the floating worm segment and the second bearing assembly. These spacers have the same thickness as the free height of the springs. In other words, the spacers occupy the same dimension as the unloaded springs, this assures that the unloaded spring dimension is maintained and the springs are not compressed once installed.

The worm is then removed from the housing, the spacers are removed and the springs are put in place and the speed reducer housing is then reassembled. The result is an assembly with a spring force of zero. The spring assemblies are configured to provide a full range of force, from the lightest to the greatest required for the particular speed reducer assembly. This will make each speed reducer assembly adjustable generally throughout its entire operating range, at assembly and in the field, without changing shims, springs or spacers. Because the spring force is accurately set at assembly, changing the spring force in the field is predictable.

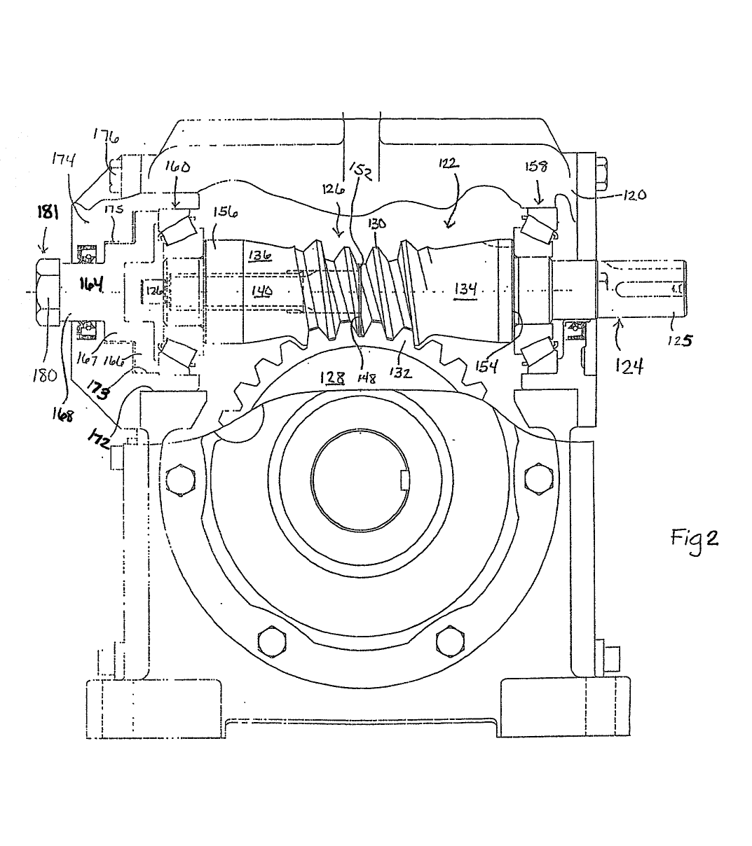

Another embodiment of the present invention is shown in FIG. 2. A housing 120 contains a speed reducer assembly 122. The low drag zero backlash speed reducer assembly 122 includes an input shaft 124, a worm 126 and a circular gear or wheel 128. As the input shaft 124 is rotated, power is transferred to the wheel 128 by way of the thread 130 which meshes with the teeth 132 of the wheel 128.

The worm 126 is comprised of a fixed worm segment 134 and a floating worm segment 136. The input shaft 124 includes a splined portion 140 extending axially from the inner end 148 of the fixed worm segment 134. The input shaft 124 and the fixed worm segment 134 are positioned such that the inner end 148 of the fixed worm segment 134 is aligned with the center of the wheel 128.

The floating worm segment 136 includes a spline along its inner axis which reciprocates the splined portion 140 of the input shaft 124. The floating worm segment 136 is slidably mounted over the splined portion of the input shaft 124 and is positioned so that the inner end 152 of the floating worm segment 136 is aligned with the center of the wheel 128 and proximate to the inner end 148 of the fixed worm segment 134. The thread 130 is formed such that when the inner end 152 of the floating worm segment 136 is proximate to the inner end 148 of the fixed worm segment 134, a nearly continuous thread is formed from the fixed worm segment 134 to the floating worm segment 136. The input shaft 124 is mounted within the housing 120 such that the thread 130 meshes with the teeth 132 of the wheel 128.

The diameter of the fixed worm segment 134 is narrower at its inner end 148 than at its outer end 154. The diameter of the floating worm segment 136 is also narrower at its inner end 152 that at its outer end 156. Thus, the fixed worm segment 134 and the floating worm segment 136 together form a double-enveloping worm. Although the embodiment shown implements a double-enveloping worm, a cylindrically shaped worm could also be implemented.

A first end 125 of the input shaft 124 extends through and is supported by a first bearing assembly 158 which is mounted in the housing 120. A second end 126 of the input shaft 124 extends through the floating worm segment 136 which is supported by a second bearing assembly 160. The second bearing assembly 160 is mounted within the housing 120.

An aperture 172, axially aligned with the input shaft 124, is provided through the housing 120 and an adjuster cap 174 is provided within the aperture 172. An aperture 173, axially aligned with the input shaft 124, is provided through the adjuster cap 174 and an adjuster 164 is mounted within the aperture 173. The adjuster 164 includes and inner portion 166, a middle portion 167 and an outer portion 168. The inner portion 166 of the adjuster 164 is generally cylindrically shaped and its diameter is generally the same as the diameter of the second bearing assembly 160. The inner portion 166 of the adjuster 164 contacts the second bearing assembly 160. The middle portion 167 of the adjuster 164 is also generally cylindrically shaped and its diameter is smaller than the diameter of the inner portion 166. The outer portion 168 of the adjuster 164 is also generally cylindrically shaped and has a smaller diameter than the middle portion 167 and extends through the aperture 172 located at the center of an adjuster cap 174.

An adjuster screw 181 is fixed to the adjuster 164. The adjuster cap 174 is mounted to the housing 120 through the use of screws 176. Fine pitch threads 175 are located on the outer surface of the middle portion 167 of the adjuster 164. The threads 175 mate with reciprocal threads in the apperature 173 in the adjuster cap 174. The fine pitch threads 175 allow for high adjustment resolution and self-locking attributes. Wrench flats 180 are provided on the outer surface of the adjuster screw 181 to assist in rotation of the adjuster screw 181. When the adjuster screw is rotated the adjuster 164 will also rotate, the adjuster 164 pushes the second bearing assembly 160 inward which causes the floating worm segment 136 to move inwardly. Rotation of the adjuster 164 in the opposite direction will allow the floating worm segment 136 to move outwardly. The adjuster 164 functions to controllably, precisely position the floating worm segment 136.

The adjuster 164 provides a means for adjusting the position of the floating worm segment 136 without requiring the disassembly of the speed reducer assembly 122 or opening of the speed reducer housing 120. The speed reducer assembly 22, shown in FIG. 1, operates with a constant spring force used to maintain zero backlash up to a specified back driving torque. The spring 62 acting on the floating worm segment 36 in the speed reducer assembly 22 exerts a constant force on both sides of the gear teeth 32. This force is slightly higher than the thrust generated by the specified back driving force. Thus, the gear tooth 32 is essentially squeezed between the worm thread 30 on the floating worm segment 34 and the fixed worm segment 36. This squeezing causes friction between the worm 26 and the gear 28, sometimes referred to as “drag”, which can cause inefficiencies in performance and wear on the gear.

Unlike the speed reducer 22, shown in FIG. 1, the speed reducer assembly 122 does not include a spring positioned at the outer end 156 of the floating worm segment 136. Using the adjuster 164, the speed reducer 122 achieves zero backlash performance without the constant residual drag generated by spring loading. Elimination of the spring-induced friction improves the efficiency, performance and gear life of the speed reducer assembly.

Periodically, the speed reducer assembly 122 will need to be adjusted to maintain zero backlash. Adjustment of the speed reducer assembly will ensure low force contact with the gear teeth 132.

Upon assembly of the speed reducer assembly 122, initial adjustment of the speed reducer assembly 122 with zero backlash is achieved by rotating the adjuster 164 until contact is made between the thread 130 on the floating worm segment 136 and the gear tooth 132. Next, backlash is checked at various points on the gear to confirm that zero backlash has been achieved. If necessary the adjuster 164 is rotated to further adjust the floating worm segment 136. After the floating worm 136 is properly adjusted to remove all backlash, in operation, little friction is caused by the gear teeth 132 being squeezed by the worm thread 130. Inherent elasticity in the bearing assemblies 158, 160 and structural elements of the speed reducer assembly will function to accommodate variations in tooth thickness that might otherwise bind the speed reducer assembly.

In the field, further adjustment of the speed reducer assembly 122 may need to be made to eliminate backlash caused by normal wear of gear teeth, bearings, etc. Such field adjustment may be accomplished by repeating the process used during assembly of the speed reducer assembly.

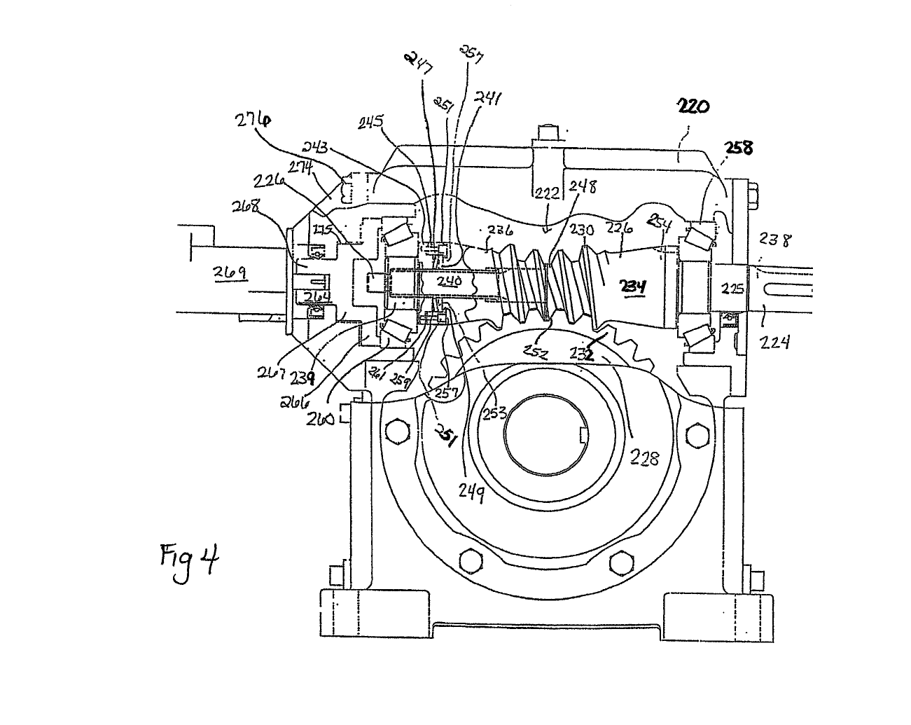

The speed reducer assembly 122 of FIG. 2 has been shown in connection with means for manually adjusting the position of the floating worm segment. However, adjustment of the position of the floating worm segment can also be accomplished automatically through the use of an automated adjustment program which periodically monitors the backlash and adjusts the speed reducer assembly as required. In this instance, a positioning motor, such as a stepper or servo motor 269 shown in FIG. 4, is employed to effectuate rotation of the adjuster 164. Logic for “homing” or “re-zeroing” the adjuster is provided to the positioning motor through a stand alone motor control which requires only AC voltage to operate. Alternatively, logic for the “homing” or “re-zeroing” function can be integrated into the machine logic controlling the machinery on which the speed reducer assembly 122 is mounted.

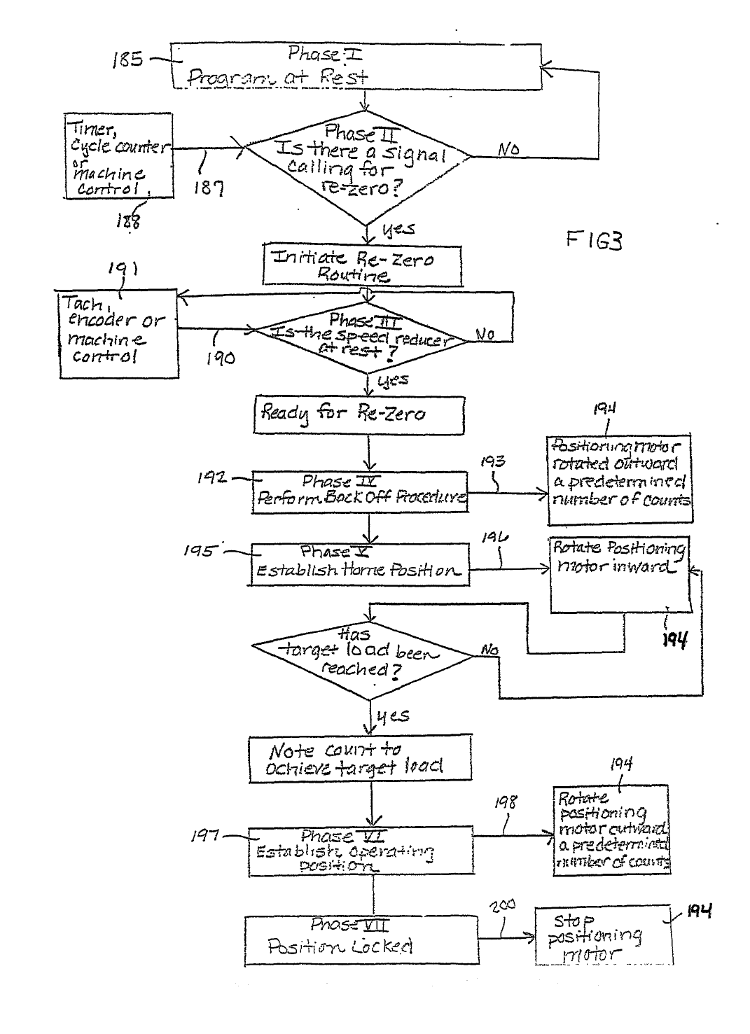

A block diagram representing the logical steps carried out by the automated adjustment program is shown in FIG. 3. The automated adjustment program includes seven phases of operation which function to achieve a zero backlash alignment between the worm and the gear.

During phase I (185 in FIG. 3) of the program, the speed reducer assembly is in operation and the adjustment program is at rest.

During phase II (186 in FIG. 3) of the program, a signal 187 is generated from a timer or cycle counter 188 which calls for re-zeroing of the speed reducer assembly 122, this signal is acted on and the re-zeroing routine is initiated.

During phase III (189 in FIG. 3) of the program, the speed reducer assembly 122 is checked to ensure the speed reducer assembly 122 is at rest and that no load is present. A signal 190 generated by a tach or encoder 191 can be used to verify that there is no angular velocity or signal indicating change in counts and that no output torque signal exists. The purpose of phase III is to ensure that the speed reducer 122 is ready for re-zero without influence from external forces. At this point in the machine's cycle, the system is at rest and there is minimal external output torque back driving the speed reducer assembly.

If the re-zeroing logic has been integrated with the machine logic rather than through a stand alone motor control, the signal 187 to initiate the re-zero routine will be received from the machine control. In addition, the machine controls can be used to verify that the speed reducer assembly is at rest and that no load is present.

During phase IV (192 in FIG. 3) of the program, a “back off” procedure is performed. During phase IV, a signal 193 is generated which instructs the positioning motor 194 to rotate a small preprogrammed number of counts and rotates the adjuster 164 in the outward direction, to un-clamp the floating worm segment 126. This “back off” procedure creates clearance in the mesh between the worm 126 and the gear 128.

During phase V (195 in FIG. 3) of the program, a home position is established. During this phase V, a signal 196 is generated which instructs the positioning motor 194 to rotate the adjuster 164 in the inward direction. As the adjuster 164 is rotated inward, the elements of the speed reducer assembly 122 are compressed causing a resistance. The positioning motor 194 continues to rotate the adjuster 164 until the torque or amperage reaches a target load. The servo or stepper motor count needed to achieve this target load is noted. This process will establish the point at which the floating worm segment 136 is forcibly loaded against the gear teeth 132 and the gear teeth 132 are clamped firmly between the floating worm segment 136 and the fixed worm segment 134.

During phase VI (197 in FIG. 3) of the program, a signal 198 is generated which instructs the positioning motor 194 to rotate outward for a small, preprogrammed number of counts. This procedure places the floating worm segment 136 in the operating position. In this operating position, the floating worm segment 136 is in contact with the gear 128, but not forcibly.

During phase VII (199 in FIG. 3) of the program, a signal 200 is generated which stops the positioning motor 194. During this phase, the axial position of the adjuster 164 and the floating worm segment 136 is locked. The axial position of the floating worm segment 136 is fixed in one direction due to the abutment of the floating worm segment 136 and the adjuster 164 and in the opposite direction due to the engagement of the worm thread 130 and the abutting the gear teeth 132.

Phase IV (191) and phase V (194) of the program may be repeated multiple times in sequence, to ensure that any lost-motion in the speed reducer assembly 122 is removed.

The speed reducer assembly 122 allows for simple axial adjustments to worm 126 to eliminate backlash. Because a spring is not provided in the speed reducer assembly 122, a constant residual drag between the thread 130 and the gear teeth 132 which would otherwise be imparted by a spring is eliminated. The speed reducer assembly 122 utilizes the inherent elasticity in the bearing assemblies 158, 160 and structural elements to allow the floating worm segment 136 to move axially to accommodate small differences in gear tooth thickness and run out.

In addition to drag caused by the constant force of a spring, drag can also be caused by differences in tooth thickness. In some applications of the zero backlash speed reducer assembly, the process in which the reducer is incorporated can not tolerate the torque fluctuations or transmission error caused by the drag from differences in tooth thickness. For these applications, a low drag speed reducer assembly equipped with a spring can be utilized.

A low drag, zero backlash speed reducer assembly 222 incorporating a motor driven adjuster and a spring is shown in FIG. 4. As described below, the spring will allow a softer, more controlled movement of the floating worm segment as the differences in tooth thickness are accommodated.

The speed reducer assembly 222 is similar to the speed reducer assembly 122. The speed reducer assembly 222 is contained in a housing 220. The speed reducer assembly 222 generally includes an input shaft 224, a worm 226 and a circular gear or wheel 228. As the input shaft 224 is rotated, power is transferred to the wheel 228 by way of the thread 230 which meshes with teeth 232 of the wheel 228.

The worm 226 is comprised of a fixed worm segment 234 and a floating worm segment 236. The input shaft 224 includes a first portion 238 extending from the outer end 254 of the fixed worm segment 234 and a splined portion 240 extending axially from the inner end 248 of the fixed worm segment 234. The input shaft 224 and the fixed worm segment 234 are positioned such that the inner end 248 of the fixed worm segment 234 is aligned with the center of the wheel 228.

The floating worm segment 236 includes a spline along its inner axis which reciprocates the splined portion 240 of the input shaft 224. The floating worm segment 236 is slidably mounted over the splined portion 240 of the input shaft 224 and is aligned with the center of the wheel 228 and proximate the inner end 248 of the fixed worm segment 234. The thread 230 is formed such that when the inner end 252 of the floating worm segment 236 is proximate the inner end 248 of the fixed worm segment 234 a nearly continuous thread is formed from the fixed worm segment 234 to the floating worm segment 236. A protuberance 241 extends from the outer end of the floating worm segment 236.

A bearing portion 239 is provided near the second end 226 of the input shaft 224. The interior of the bearing portion 239 includes a spline which reciprocates the splined portion 240 of the input shaft 224. The bearing portion 239 is slidably mounted on the input shaft 224. The second end 226 of the input shaft 224 extends through the bearing portion 239 and is supported by the bearing portion 239. An abutment 243 is provided on the inner end of the bearing portion 239.

A spring retainer 245 is positioned between the floating worm segment 236 and the bearing portion 239. The spring retainer 245 is shaped to contain a disc spring 247 and is mounted to the abutment 243 of the bearing portion 239 with screws 251. A retaining plate 253 is mounted on the inner end of the spring retainer 245. A shoulder 257 proximate the inner end of the spring retainer 245 retains the retaining plate 253 within the spring retainer 245. When the spring retainer 245 is mounted to the bearing portion 239 a pocket 259 is formed between the bearing portion 239 and the retaining plate 253. A spring 247 is positioned within the pocket 259. The spring 247 has a very high spring force. The spring retainer 245 includes an axial bore 249 which allows the protuberance 241 of the floating worm segment 236 to clear the shoulder 257 of the spring retainer 245 and to contact the retaining plate 253. Although the protuberance 241 of the floating worm segment 236 contacts the retaining plate 253, a gap 255 is provided between the spring retainer 245 and the surface 263 at the outer end of the floating worm segment 236. Shims 261 are positioned between the bearing portion 239 and the spring retainer 245.

An adjuster 264 is mounted within an adjuster cap 274 in the same manner as the adjuster 164 shown in FIG. 2. The adjuster cap 274 is mounted proximate the second bearing assembly 260. The adjuster 264 has an inner portion 266, a middle portion 267, and an outer portion 268. The inner portion 266 of the adjuster 264 is generally cylindrically shaped and its diameter is the generally the same as the diameter of the second bearing assembly 260. The middle portion 267 is also generally cylindrically shaped and its diameter is smaller than the diameter of the inner portion 266. The outer portion 268 of the adjuster 264 is also generally cylindrically shaped and its diameter is smaller than the diameter of the middle portion 267.

The adjuster cap 274 is mounted to the housing 220 through the use of screws 276. Threads 275 are located on the surface of the middle portion 267 of the adjuster 264 which mate with reciprocal threads in the hole of the adjuster cap 274. The mating threads allow the adjuster 264 to be rotated and secured into a desired position. The inner portion 266 of the adjuster 264 contacts the second bearing assembly 260. A positioning motor 269 such as a servo or stepped motor, is mounted to the adjuster cap 274 and serves to rotate the adjuster 264.

As the adjuster 264 is rotated in inward, the inner portion 266 of the adjuster 264 pushes the second bearing assembly 260, causing the second bearing assembly 260 and the bearing portion 239 mounted within the bearing assembly 260 to move inward. As the bearing portion 239 moves inward, the spring retainer 245 which is mounted to the bearing portion 239 also moves inward. As the spring retainer 245 moves inward, the floating worm segment 236 also moves inward due to the contact between the spring retainer 245 at the protuberance 241 of the floating worm segment 236.

Rotation of the adjuster 264 in the opposite direction allows for outward movement of the bearing portion 239 and bearing assembly 260, the spring retainer 245, and the floating worm segment 236. The adjuster 264 functions to controllably and precisely position the floating worm segment 236.

When the speed reducer 222 is assembled, the spring 247 will be pre-loaded to a force slightly greater than the axial force to be imparted on the worm at the condition of maximum output torque expected for the speed reducer's application. The desired pre-load on the spring 247 will be achieved by selecting the disc springs with the appropriate dimensions and force capacity. The spring 247 will be preloaded by compressing them by a calculated, fixed amount when assembled between the bearing portion 239 and the spring retainer 245. Shims 261 will be added or removed to achieve the correct compression. This required amount of linear displacement can be calculated using Almen and Lazlo's formulae.

Operation of the speed reducer assembly 222 will be identical to the operation of the speed reducer 122 previously described. Adjustment of the speed reducer assembly 222 can also be accomplished in the same manner as the adjustment of the speed reducer assembly 122. The adjustment can be accomplished manually or through the use of a motor 269, such as for example, a servo or stepper motor. The re-zero routine will set the position of the floating worm segment 236 at zero backlash, without imparting spring induced drag on the teeth. The spring will compress additionally only when the floating worm segment 236 is displaced by a thick gear tooth 232. When a thick gear tooth 232 is encountered, the contact between the protuberance 241 of the floating worm segment 236 and the retaining plate 253 will cause the floating worm segment 236 to act on the pre-loaded spring 247 which will allow axial movement of the floating worm segment 236. As the force of the spring 247 is displaced, the gap 255 closes. When the thick gear tooth 232 has cleared the worm thread 230, the speed reducer assembly 222 will return to the condition where there is zero backlash between the gear teeth 232 and worm thread 230, without additional drag imparted by the spring 247.

While preferred embodiments of the present invention are shown and described, it is envisioned that those skilled in the art may devise various modifications of the present invention without departing from the spirit and scope of the appended claims.

The invention claimed is:

1. A speed reducer assembly comprising;
a housing;
a fixed worm segment, said fixed worm segment defining an axis of rotation;
a shaft extending from said fixed worm segment, generally concentric with said axis of rotation;
a floating worm segment axially positioned on said shaft;
a first bearing assembly mounted at the outer end of the fixed worm segment;
a second bearing assembly mounted at the outer end of the floating worm segment;
means for transmitting torque from said shaft to said floating worm segment and said second bearing assembly;
a thread along the length of said fixed worm segment and said floating worm segment for engagement with gear teeth; and
means for controllably adjusting a position of said floating worm segment.

2. A speed reducer assembly as defined in claim 1, wherein
the diameter of said fixed worm segment is smaller at its inner end than at its outer end; and
the diameter of said floating worm segment is smaller at its inner end than that at its outer end.

3. A speed reducer assembly as defined in claim 1, wherein
said means for transmitting torque from said shaft to said floating worm segment comprises a spline on said shaft and a reciprocating spline on the inner diameter of said floating worm segment.

4. A speed reducer assembly as defined in claim 1, wherein said means for adjusting said position of said floating worm segment is an adjuster cap secured to said housing with a hole there through and an adjuster extending through said hole, threadedly mated to said adjuster cap, and contacting said bearing assembly.

5. A speed reducer assembly as defined in claim 4, further including a positioning motor attached to said adjuster and configured to rotate said adjuster.

6. A speed reducer assembly as defined in claim 5, wherein said positioning motor is one of a servo motor and a stepped motor.

7. A speed reducer assembly as defined in claim 5, further including an automated adjustment program in communication with said positioning motor.

8. A speed reducer assembly as defined in claim 7, wherein said automated adjustment program is programed to identify a current backlash status of said speed reducer assembly and to reposition said speed floating worm segment to obtain a zero backlash status.

9. A speed reducer assembly as defined in claim 7, wherein said automated adjustment program is programed to perform the following process:
act on a first signal which calls for re-zeroing the speed reducer assembly,
verify that the speed reducer assembly is at rest, generate a second signal which directs said positioning motor to rotate the adjuster outwardly,
generate a third signal to rotate the adjuster inwardly until a target load is reached,
identify the motor count needed to achieve said target load, and
generate a fourth signal which instructs said positioning motor to rotate outward a pre-determined number of counts.

10. A speed reducer assembly as defined in claim 1, wherein said second bearing assembly is mounted within a bearing portion and further including:
a spring retainer mounted to said bearing portion;
a spring positioned within said spring retainer proximate the outer end of said floating worm segment; and
a protuberance extending from said outer end of said floating worm segment and in contact with said spring retainer.

11. A speed reducer assembly as defined in claim 10, wherein said spring retainer further includes a retaining plate positioned proximate said spring and wherein said protuberance of said floating worm segment contacts said retaining plate.

12. A speed reducer assembly as defined in claim 9, wherein said spring is pre-loaded to a force slightly greater than an expected maximum axial force on the floating worm segment.

13. A speed reducer assembly as defined in claim 9, further including shims positioned between said spring retainer and said bearing portion.

14. A method of adjusting the position of a worm in a speed reducer assembly relative to a gear, comprising the steps of:
providing a speed reducer assembly comprising:
a housing;
a fixed worm segment, said fixed worm segment defining an axis of rotation;
a shaft extending from said fixed worm segment, generally concentric with said axis of rotation;
a floating worm segment axially positioned on said shaft;
a first bearing assembly mounted at the outer end of the fixed worm segment;
a second bearing assembly mounted at the outer end of the floating worm segment;
means for transmitting torque from said shaft to said floating worm segment and said second bearing assembly;
a thread along the length of said fixed worm segment and said floating worm segment for engagement with gear teeth;
an adjuster cap secured to said housing, said adjuster cap providing a hole there through;
an adjuster threadedly mated to said adjuster cap and extending through said hole of said adjuster cap;
providing a positioning motor attached to the adjuster;
providing a motor control configured to perform a re-zeroing routine comprising the steps of;
identifying a current backlash status of said speed reducer assembly, and
rotating said adjuster to achieve a zero backlash status.

15. A method of adjusting the position of a worm in a speed reducer assembly relative to a gear, as defined in claim 14 wherein said re-zeroing routine further comprises the steps of:
acting on a first signal to initiate a re-zeroing routine;
verifying that the speed reducer is at rest and that no load is present;
sending a second signal to said positioning motor to rotate a predetermined number of counts;
sending a third signal to the positioning motor to advance the adjuster until a target load is reached; and
sending a fourth signal to reverse the positioning motor for a predetermined number of counts.
